(19) United States
(12) Patent Application Publication
(10) Pub. No.: US 2009/0202837 A1
(43) Pub. Date: Aug. 13, 2009

(54) Moisture-Curing Polyurethane Composition with Good Low-Temperature Performance

(75) Inventors: Ukiwo Onuoha, Bassersdorf (CH); Urs Burckhardt, Zürich (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/224,886

(22) PCT Filed: Mar. 13, 2007
(86) PCT No.: PCT/EP2007/052352

§ 371 Date: Sep. 9, 2008

(30) Foreign Application Priority Data
Mar. 13, 2006 (EP) 06111028.4

(51) Int. Cl. B32B 27/40; C09J 175/04; C09J 133/24; B32B 27/08

(52) U.S. Cl. 428/413; 525/459; 525/454; 524/425; 156/331.4; 428/425.6; 428/425.8; 428/424.6; 428/423.7; 428/425.5

(57) ABSTRACT

The present invention relates to one-component moisture-curing compositions comprising at least one isocyanate-containing polyurethane polymer P which has a mean molecular weight of at least 4000 g/mol, and at least one polyaldimine ALD of the formula (I) or (II), where the content of isocyanate groups is at most 3.5% by weight, based on the sum of the isocyanate-containing constituents present in the composition. The compositions are suitable especially as sealants and are notable for good low-temperature performance.

### FIELD OF THE INVENTION

The present invention pertains to the field of one-component moisture-curing polyurethane compositions, and also to their uses, more particularly as sealants.

### DESCRIPTION OF THE PRIOR ART

The use of one-component moisture-curing polymer compositions as sealants for seals in building, such as expansion joints in construction or civil engineering, for example, is known. These sealants are to be stable on storage and are to cure rapidly under the influence of moisture, more particularly in the form of atmospheric humidity, so as, following application, not to become soiled and/or quickly to be amenable to overcoating. Furthermore, such sealants are as far as possible to be flexible, in other words to have low values for the elongation stress in the low elongation range up to 100% and at the same time to have a high resilience, in order to bridge expansions and shifts in the sealed substrates reversibly and with as little force as possible.

Polymer compositions preferred for this use are one-component polyurethane materials which comprise free isocyanate groups. However, on account of the carbon dioxide that is formed during the hydrolysis of the isocyanate groups, such materials have a tendency to form bubbles on curing. Moreover, at low temperatures, there is an increase in their elongation stress, in some cases considerably so, which is highly undesirable particularly in the case of applications in the exterior segment.

One-component polyurethane materials which cure without bubbles are known. They have been described, for example, in U.S. Pat. No. 3,420,800 or U.S. Pat. No. 4,853,454. These systems comprise latent polyamines, in the form for example of polyaldimines, which as a result moisture-cure with little or no formation of carbon dioxide, thus preventing bubbling. However, these systems have extension stresses which are too high for application as flexible construction sealants.

Polyurethane materials comprising latent polyamines having flexible properties are known, from EP-A-1 329 469 for example. Compositions are disclosed which comprise short-chain polyaldimines and prepolymers based on long linear polyoxyalkylene polyols with a low degree of unsaturation. In this way, low values are obtained for the elongation stress at room temperature. However, the elongation stress values of these systems too rise significantly at low temperatures.

Long-chain polyaldimines and their use in polyurethane materials are likewise described: for example, in U.S. Pat. No. 4,983,659 as a RIM system; in U.S. Pat. No. 4,990,548 as a polyurethane foam; or in U.S. Pat. No. 5,466,771 as a two-component coating.

### SUMMARY OF THE INVENTION

It is an object of the present invention to improve the one-component polyurethane compositions known to date from the prior in respect of their application as flexible sealants. These sealants are to be stable on storage, to cure rapidly and without formation of bubbles, to exhibit good resilience after they have cured, and to possess a 100% elongation stress which as far as possible is consistently low both at room temperature and at −20° C.

It has been found that the use of specific polyaldimines of the kind described in claim 1 as latent curatives in one-component moisture-curing polyurethane compositions leads to a significant improvement to the flexible sealants known from the prior art. More particularly there is only a slight rise in the 100% elongation stress on cooling from room temperature to −20° C. In other words, the stress at 100% elongation, measured at room temperature and measured at −20° C., is virtually the same.

### DESCRIPTION OF THE PREFERRED EMBODIMENTS

The present invention provides one-component moisture-curing compositions comprising
a) at least one polyurethane polymer P which contains isocyanate groups and has an average molecular weight of at least 4000 g/mol, and
b) at least one polyaldimine ALD of the formula (I) or (II),

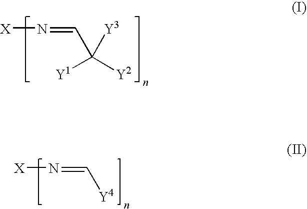

where X is the radical of an n-functional polyamine having aliphatic primary amino groups and an average amine equivalent weight of at least 180 g/eq, preferably at least 220 g/eq, following removal of n amino groups;
n is 2 or 3,
Y¹ and Y² either independently of one another are each a monovalent hydrocarbon radical having 1 to 12 C atoms, or together form a divalent hydrocarbon radical having 4 to 20 C atoms which is part of an unsubstituted or substituted carbocyclic ring having 5 to 8, preferably 6, C atoms, and
Y³ is a monovalent hydrocarbon radical which where appropriate has at least one heteroatom, more particularly oxygen in the form of ether, carbonyl or ester groups;
Y⁴ either is a substituted or unsubstituted aryl or heteroaryl group which has a ring size of between 5 and 8, preferably 6, atoms,
   or is

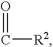

where R² is a hydrogen atom or is an alkoxy group;
or is a substituted or unsubstituted alkenyl or arylalkenyl group having at least 6 C atoms;
   the isocyanate group content thereof being not more than 3.5% by weight, based on the sum of the isocyanate-group-containing constituents present in the composition.

A composition of this kind, after curing, has the property that the 100% elongation stress measured at room temperature (“σ_{100%(RT)}”) and measured at −20° C. (“σ_{100%(-20° C.)}”) is almost the same. The composition is especially suitable as a flexible sealant for sealing joints of built structures in the exterior segment.

The term “polymer” in the present document embraces on the one hand a collective of macromolecules which, while being chemically uniform, differ in respect of degree of polymerization, molar mass, and chain length, and have been prepared by means of a polymerization reaction (addition polymerization, polyaddition or polycondensation). On the other hand the term also embraces derivatives of such a collective of macromolecules from polymerization reactions, in other words compounds which have been obtained by reactions, such as additions or substitutions, for example, of functional groups on existing macromolecules and which may be chemically uniform or chemically nonuniform. The term further embraces what are called prepolymers, in other words reactive oligomeric preadducts whose functional groups have participated in the synthesis of macromolecules.

The term “polyurethane polymer” embraces all polymers which are prepared by the process known as the diisocyanate polyaddition process. This also includes those polymers which are virtually or entirely free of urethane groups. Examples of polyurethane polymers are polyether-polyurethanes, polyester-polyurethanes, polyether-polyureas, polyureas, polyester-polyureas, polyisocyanurates, and polycarbodiimides.

The term “polyamine” here and below identifies aliphatic primary diamines or triamines, in other words compounds which formally contain two or three primary amino groups (NH₂ groups) which are attached to an aliphatic, cycloaliphatic or arylaliphatic radical which where appropriate may contain heteroatoms. They therefore differ from the aromatic primary polyamines, in which the NH₂ groups are attached directly to an aromatic or heteroaromatic radical, such as in diaminotoluene, for example.

The term “amine equivalent weight” in the present document identifies the mass of a polyamine that contains 1 mol of primary amino groups.

The term “elongation stress” (“σ”) identifies the stress which acts in a material in the extended state. The term “100% elongation stress” (“σ_{100%}”) identifies the stress which acts in a material which has been extended to twice its length, also referred to as “stress at 100% elongation”.

The term “average molecular weight” or else simply “molecular weight”, if it refers to molecular mixtures, more particularly to mixtures of oligomers or polymers, and not to pure molecules, in the present document identifies the molecular weight average Mₙ (number average).

The moisture-curing composition comprises at least one polyurethane polymer P which contains isocyanate groups and has an average molecular weight of at least 4000 g/mol. The polyurethane polymer P is obtainable more particularly through the reaction of at least one polyisocyanate with at least one polyol, the NCO/OH ratio having a value of not more than 2.5, more particularly not more than 2.2.

This reaction may take place by the polyol and the polyisocyanate being reacted by typical techniques, at temperatures of 50° C. to 100° C. for example, where appropriate with the accompanying use of suitable catalysts, the polyisocyanate being metered such that its isocyanate groups are present in a stoichiometric excess in relation to the hydroxyl groups of the polyol. Advantageously the polyisocyanate is metered so as to observe an NCO/OH ratio of ≦2.5, preferably ≦2.2. The NCO/OH ratio here means the ratio of the number of isocyanate groups employed to the number of hydroxyl groups employed. Preferably, after all of the hydroxyl groups of the polyol have reacted, a free isocyanate group content of 0.5% to 3% by weight remains, based on the overall polyurethane polymer P.

Where appropriate the polyurethane polymer P can be prepared with the accompanying use of plasticizers, the plasticizers used containing no isocyanate-reactive groups.

Examples of polyols which can be used for the preparation of a polyurethane polymer P are the following commercially customary polyols or mixtures thereof:
polyoxyalkylenepolyols, also called polyetherpolyols or oligoetherols, which are polymerization products of ethylene oxide, 1,2-propylene oxide, 1,2- or 2,3-butylene oxide, tetrahydrofuran or mixtures thereof, possibly polymerized by means of a starter molecule having two or more active hydrogen atoms, such as water, ammonia or compounds having two or more OH or NH groups such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the aforementioned compounds. Use may be made both of polyoxyalkylenepolyols which have a low degree of unsaturation (measured as claimed in ASTM D-2849-69 and reported in milliequivalents of unsaturation per gram of polyol (meq/g)), prepared for example with the aid of what are known as double metal cyanide complex catalysts (DMC catalysts), and of polyoxyalkylenepolyols having a higher degree of unsaturation, prepared for example by means of anionic catalysts such as NaOH, KOH, CsOH or alkali metal alkoxides.

Particular suitability is possessed by polyoxyalkylenediols or polyoxyalkylenetriols, more particularly polyoxypropylenediols or polyoxypropylenetriols.

Especially suitable are polyoxyalkylenediols or polyoxyalkylenetriols having a degree of unsaturation of less than 0.02 meq/g and having a molecular weight in the range of 1000-30 000 g/mol, and also polyoxypropylenediols and -triols having a molecular weight of 400-8000 g/mol.

Likewise particularly suitable are what are known as ethylene oxide-terminated (“EO-endcapped”, ethylene oxide-endcapped) polyoxypropylenepolyols. The latter are specific polyoxypropylene-polyoxyethylene-polyols which are obtained, for example, by subjecting pure polyoxypropylenepolyols, more particularly polyoxypropylenediols and -triols, after the end of the polypropoxylation reaction, to further alkoxylation with ethylene oxide and which as a result contain primary hydroxyl groups.
Styrene-acrylonitrile- or acrylonitrile-methyl methacrylate-grafted polyetherpolyols.
Polyesterpolyols, also called oligoesterols, prepared for example from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, and also polyesterpolyols formed from lactones such as ε-caprolactone, for example.
Polycarbonatepolyols of the kind obtainable by reacting, for example, the abovementioned alcohols—those used to synthesize the polyesterpolyols—with dialkyl carbonates, diaryl carbonates or phosgene.
Polyacrylatepolyols and polymethacrylatepolyols.
Polyhydrocarbon-polyols, also called oligohydrocarbonols, such as, for example, polyhydroxy-functional ethylene-propylene, ethylene-butylene or ethylenepropylene-diene copolymers, of the kind prepared, for example, by the company Kraton Polymers, or polyhydroxy-functional copolymers of dienes such as 1,3-butanediene or diene mixtures and vinyl monomers such as styrene, acrylonitrile or isobutylene, or polyhydroxy-functional polybutadienepolyols, such as those, for example, which are prepared by copolymerization of 1,3-butadiene and allyl alcohol.
Polyhydroxy-functional acrylonitrile/polybutadiene copolymers of the kind preparable, for example, from epoxides or amino alcohols and carboxyl-terminated acrylonitrile/polybutadiene copolymers (available commercially under the name Hycar® CTBN from Hanse Chemie).

These stated polyols preferably have an average molecular weight of 250-30 000 g/mol, more particularly of 1000-30 000 g/mol, and preferably have an average OH functionality in the range from 1.6 to 3.

Further to these stated polyols it is possible to use small amounts of low molecular mass dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other polyhydric alcohols, low molecular mass alkoxylation products of the aforementioned dihydric and polyhydric alcohols, and also mixtures of the aforementioned alcohols, in preparing the polyurethane polymer P.

As polyisocyanates for the preparation of a polyurethane polymer P containing isocyanate groups it is possible to make use of the following commercially customary polyisocyanates, for example: 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, lysine diisocyanate and lysine ester diisocyanate, cyclohexane 1,3- and 1,4-diisocyanate and any desired mixtures of these isomers, 1-isocyanato-3,3,5-trimethyl-5-isocyanatomethylcyclohexane (i.e., isophorone diisocyanate or IPDI), perhydro-2,4′- and -4,4′-diphenylmethane diisocyanate (HMDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene, 2,4- and 2,6-tolylene diisocyanate and any desired mixtures of these isomers (TDI), 4,4′-, 2,4′-, and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODI), oligomers and polymers of the aforementioned isocyanates, and also any desired mixtures of the aforementioned isocyanates. Preference is given to MDI, TDI, HDI, and IPDI.

Owing to the average molecular weight of at least 4000 g/mol and to the NCO/OH ratio of not more than 2.5 which is advantageously observed for its preparation, the polyurethane polymer P has a relatively low isocyanate group content. As a result it is suitable for use in one-component moisture-curing compositions which have flexibility properties. A polyurethane polymer having an average molecular weight of below 4000 g/mol has a relatively high isocyanate group content. Similarly, a polyurethane polymer which has been prepared with an NCO/OH ratio greater than 2.5 has, by virtue of its relatively high unreacted polyisocyanate content, a relatively high isocyanate group content.

A high isocyanate group content in the polyurethane composition leads, after its curing with moisture, to a high urea group content in the composition. This, however, raises the elongation stress in the range up to 100% elongation to beyond the extent which is appropriate for use as a flexible sealant. Polyurethane polymers which are prepared with a significantly higher NCO/OH ratio, as for example in the order of magnitude of 8, as described for example by U.S. Pat. No. 4,983,659 in Example 2 for a RIM composition, have very high elongation stress values in the cured state. They are therefore unsuited to use as a sealant having flexibility properties.

Typically the polyurethane polymer P is present in an amount of 10%-80% by weight, preferably in an amount of 15%-50% by weight, based on the overall polyurethane composition.

Besides the polyurethane polymer p containing isocyanate groups, the one-component moisture-curing composition comprises at least one polyaldimine ALD of the formula (I) or (II).

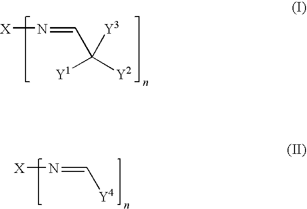

In the formulae (I) and (II), n is 2 or 3, and X stands for the radical of an n-functional polyamine having aliphatic primary amino groups and an average amine equivalent weight of at least 180 g/eq following removal of n amino groups.

Preferably X stands for a hydrocarbon radical, which is optionally substituted, and which optionally contains heteroatoms, more particularly in the form of ether oxygen, tertiary amine nitrogen, and thioether sulfur.

With particular preference X stands for a polyoxyalkylene radical, more particularly for a polyoxypropylene or a polyoxybutylene radical, it also being possible for each of these radicals to include fractions of other oxyalkylene groups.

In the formula (I) it is possible for Y¹ and Y² on the one hand, independently of one another, each to be a monovalent hydrocarbon radical having 1 to 12 C atoms.

On the other hand Y¹ and Y² together may be a divalent hydrocarbon radical having 4 to 20 C atoms which is part of an unsubstituted or substituted carbocyclic ring having 5 to 8, preferably 6, C atoms.

Y³ stands for a monovalent hydrocarbon radical which optionally contains at least one heteroatom, more particularly oxygen in the form of ether, carbonyl or ester groups.

More particularly Y³ may first be a branched or unbranched alkyl, cycloalkyl, alkylene or cycloalkylene group which optionally contains at least one heteroatom, more particularly ether oxygen.

More particularly, furthermore, Y³ may also be a substituted or unsubstituted aryl or arylalkyl group.

More particularly it is possible for Y³, finally, also to be a radical of the formula O—R¹ or

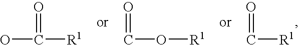

R¹ in turn standing for an aryl, arylalkyl or alkyl group and being in each case substituted or unsubstituted.

In a first preferred embodiment Y³ stands for a radical of the formula (III),

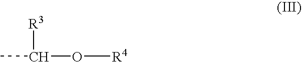

where R³ stands for a hydrogen atom or for an alkyl or arylalkyl group and R⁴ stands for an alkyl or arylalkyl group.

In a second preferred embodiment Y³ stands for a radical of the formula (IV)

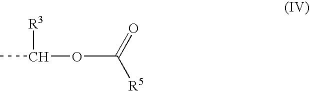

where R³ is as defined above and
R⁵ stands for a hydrogen atom or an alkyl or arylalkyl or aryl group, optionally having at least one heteroatom, more particularly having at least one ether oxygen, and optionally having at least one carboxyl group, and optionally having at least one ester group, or for a singly or multiply unsaturated linear or branched hydrocarbon chain.

In the formula (II) Y⁴ may first be a substituted or unsubstituted aryl or heteroaryl group which has a ring size of between 5 and 8, preferably 6, atoms.

Secondly Y⁴ can stand for a radical of the formula

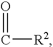

where R² in turn is a hydrogen atom or an alkoxy group.

Finally Y⁴ can stand for a substituted or unsubstituted alkenyl or arylalkenyl group having at least 6 C atoms.

A polyaldimine ALD is obtainable through a condensation reaction, with elimination of water, between a polyamine of the formula (V) with an aldehyde of the formula (VI) or (VII), where X, n, and Y¹, Y², Y³, and Y⁴ have the definitions stated above.

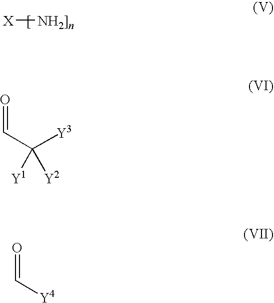

Polyamines of the formula (V) are polyamines having two or three aliphatic primary amino groups and an average amine equivalent weight of at least 180 g/eq. The radical X is devoid of moieties which are reactive with isocyanate groups in the absence of water; more particularly, X has no hydroxyl groups, secondary amine groups, urea groups or other groups containing active hydrogen. It is advantageous for the radical X to contain as few moieties as possible that tend toward crystallization at low temperatures, such as, for example, polyoxyethylene, polyester or polycarbonate groups arranged in blocks, since these moieties may adversely influence the low-temperature performance of the cured composition.

As a result of the use of polyamines of the formula (V) for the preparation of the polyaldimines ALD, the polyurethane compositions described not only have flexibility properties but are also distinguished by a low-temperature performance which is advantageous for sealants, with the stress at 100% elongation, measured at room temperature and measured at −20° C., being almost exactly the same. In the cured composition the amine equivalent weight of the polyamine employed determines the distance between the urea groups, formed by the amine-isocyanate reaction, in the cured polymer. The higher the amine equivalent weight of the polyamine, the greater the distance between these urea groups, which obviously is beneficial for the desired low-temperature performance.

Suitable polyamines of the formula (V) are prepared, for example, starting from those polyols of the kind already mentioned in relation to the preparation of the polyurethane polymer P. On the one hand the OH groups of the polyols can be converted into primary amino groups by means of amination, or the polyols are converted, by a cyanoethylation with, for example, acrylonitrile and subsequent reduction, into polyamines, or the polyols are reacted with an excess of diisocyanate, and then the terminal isocyanate groups are hydrolyzed to amino groups.

Preference is given to polyamines having a polyether parent structure, especially those having a polyoxypropylene parent structure.

Suitable commercially available polyamines having a polyether parent structure and having an amine equivalent weight of at least 180 g/eq are, for example:
polyoxypropylenediamines, such as Jeffamine® D-400, D-2000, and D-4000 (from Huntsman Chemicals), Polyetheramin D 400, D2000 (from BASF), and PC Amine® DA 400 and DA 2000 (from Nitroil);
polyoxypropylenetriamines, such as Jeffamine® T-3000 and T-5000 (from Huntsman Chemicals) and Polyetheramin T 5000 (from BASF);
polytetrahydrofurandiamines, such as Polytetrahydrofuranamin 1700 (from BASF);
diamines from the cyanoethylation of polytetrahydrofurandiols, such as Bis(3-aminopropyl)polytetrahydrofuran 750, 1000, and 2100 (from BASF);
polyoxypropylene-polytetrahydrofuran block copolymer diamines, such as Jeffamine® XTJ-533, XTJ-536, and XTJ-548 (from Huntsman Chemicals);
polyoxy(1,2-butylene)diamines, such as Jeffamine® XTJ-523 (from Huntsman Chemicals).

For the preparation of a polyaldimine ALD, aldehydes of the formula (VI) or (VII) are used. These aldehydes have the property that their radicals Y¹, Y², Y³, and Y⁴ do not contain moieties that are reactive with isocyanate groups in the absence of water; more particularly, Y¹, Y², Y³, and Y⁴ contain no hydroxyl groups, secondary amine groups, urea groups or other groups containing active hydrogen.

Suitable aldehydes of the formula (VI) are tertiary aliphatic or tertiary cycloaliphatic aldehydes, such as, for example, pivalaldehyde (i.e., 2,2-dimethylpropanal), 2,2-dimethylbutanal, 2,2-diethylbutanal, 1-methylcyclopentanecarboxaldehyde, 1-methylcyclohexanecarboxaldehyde; and also ethers of 2-hydroxy-2-methylpropanal and alcohols such as propanol, isopropanol, butanol, and 2-ethylhexanol; esters of 2-formyl-2-methylpropionic acid or 3-formyl-3-methylbutyric acid and alcohols such as propanol, isopropanol, butanol, and 2-ethylhexanol; esters of 2-hydroxy-2-methylpropanal and carboxylic acids such as butyric acid, isobutyric acid, and 2-ethylhexanoic acid; and also the ethers and esters, described below as being particularly suitable, of 2,2-disubstituted 3-hydroxypropanals, -butanals or analogous higher aldehydes, more particularly of 2,2-dimethyl-3-hydroxypropanal.

Aldehydes of the formula (VI) that are suitable more particularly are compounds of the formula (VIa)

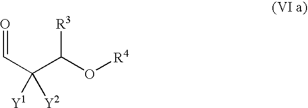

where Y¹, Y², R³, and R⁴ have the definitions already stated.

Compounds of the formula (VIa) represent ethers of aliphatic, araliphatic or alicyclic 2,2-disubstituted 3-hydroxyaldehydes, of the kind formed from aldol reactions, more particularly crossed aldol reactions, between primary or secondary aliphatic aldehydes, more particularly formaldehyde, and secondary aliphatic, secondary araliphatic or secondary alicyclic aldehydes, such as, for example, 2-methylbutyraldehyde, 2-ethylbutyraldehyde, 2-methylvaleraldehyde, 2-ethylcapronaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde (hydrotrope aldehyde) or diphenylacetaldehyde, with alcohols, such as, for example, methanol, ethanol, propanol, isopropanol, butanol, 2-ethylhexanol or fatty alcohols. Examples of compounds of the formula (VIa) are 2,2-dimethyl-3-methoxypropanal, 2,2-dimethyl-3-ethoxypropanal, 2,2-dimethyl-3-isopropoxypropanal, 2,2-dimethyl-3-butoxypropanal, and 2,2-dimethyl-3-(2-ethylhexyloxy)propanal.

Further aldehydes of the formula (VI) that are suitable more particularly are compounds of the formula (VIb)

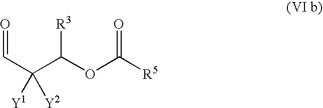

where Y¹, Y², R³, and R⁵ have the definitions already stated.

Compounds of the formula (VIb) represent esters of the above-described 2,2-disubstituted 3-hydroxyaldehydes, such as, for example, 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal, with aliphatic or aromatic carboxylic acids, such as, for example, formic acid, acetic acid, propionic acid, butyric acid, isobutyric acid, valeric acid, caproic acid, 2-ethylcaproic acid, capric acid, lauric acid, myristic acid, palmitic acid, stearic acid, and benzoic acid. Preferred compounds of the formula (VIb) are esters of 2,2-dimethyl-3-hydroxypropanal and the stated carboxylic acids, such as, for example, 2,2-dimethyl-3-formyloxypropanal, 2,2-dimethyl-3-acetoxypropanal, 2,2-dimethyl-3-isobutyroxypropanal, 2,2-dimethyl-3-(2-ethylhexanoyloxy)propanal, 2,2-dimethyl-3-lauroyloxypropanal, 2,2-dimethyl-3-palmitoyloxypropanal, 2,2-dimethyl-3-stearoyloxypropanal and 2,2-dimethyl-3-benzoyloxypropanal, and also analogous esters of other 2,2-disubstituted 3-hydroxyaldehydes.

In one preferred preparation method of an aldehyde of the formula (VIb) a 2,2-disubstituted 3-hydroxyaldehyde, an example being 2,2-dimethyl-3-hydroxypropanal, which is preparable, for example, from formaldehyde (or paraformaldehyde) and isobutyraldehyde, where appropriate in situ, is reacted with a carboxylic acid to form the corresponding ester. This esterification can take place without the use of solvents by known methods, as described for example in Houben-Weyl, “Methoden der organischen Chemie”, Vol. VIII, pages 516-528.

It is also possible to prepare aldehydes of the formula (VIb) by carrying out the esterification of a 2,2-disubstituted 3-hydroxyaldehyde using an aliphatic or cycloaliphatic dicarboxylic acid, such as succinic acid, adipic acid or sebacic acid, for example. In this way, corresponding tertiary aliphatic or tertiary cycloaliphatic dialdehydes are obtained.

In one particularly preferred embodiment the aldehydes of the formula (VI) are odorless. By an “odorless” substance is meant a substance which is so low in odor that for the majority of human individuals it cannot be smelled, in other words cannot be perceived with the nose.

Odorless aldehydes of the formula (VI) are, more particularly, aldehydes of the formula (VIb), in which the radical R⁵ either stands for a linear or branched alkyl chain having 11 to 30 carbon atoms, optionally with at least one heteroatom, more particularly with at least one ether oxygen, or stands for a singly or multiply unsaturated linear or branched hydrocarbon chain having 11 to 30 carbon atoms.

Examples of odorless aldehydes of the formula (VIb) are esterification products formed from the aforementioned 2,2-disubstituted 3-hydroxyaldehydes with carboxylic acids such as, for example, lauric acid, tridecanoic acid, myristic acid, pentadecanoic acid, palmitic acid, margaric acid, stearic acid, nonadecanoic acid, arachidic acid, palmitoleic acid, oleic acid, erucic acid, linoleic acid, linolenic acid, elaeostearic acid, arachidonic acid, fatty acids from the industrial hydrolysis of natural oils and fats, such as rapeseed oil, sunflower oil, linseed oil, olive oil, coconut oil, oil palm kernel oil and oil palm oil, for example, and also industrial mixtures of fatty acids that comprise these acids. Preferred aldehydes of the formula (VIb) are 2,2-dimethyl-3-lauroyloxypropanal, 2,2-dimethyl-3-myristoyloxypropanal, 2,2-dimethyl-3-palmitoyloxypropanal, and 2,2-dimethyl-3-stearoyloxypropanal. Particular preference is given to 2,2-dimethyl-3-lauroyloxypropanal.

In the course of the curing of the polyurethane composition, the aldehyde that is used to prepare the polyaldimine ALD is liberated. Many aldehydes have a very intense odor, which may be perceived as disruptive during and also, depending on the volatility of the aldehyde, after the curing of the polyurethane composition. Compositions which give rise to an odor in the course of their curing are therefore of only limited usefulness, especially in interior spaces. In the particularly preferred embodiment with odorless aldehydes, polyurethane compositions are obtained which cure odorlessly.

Suitable aldehydes of the formula (VII) are aromatic aldehydes, examples of which include benzaldehyde, 2- and 3- and 4-tolualdehyde, 4-ethyl- and 4-propyl- and 4-isopropyl- and 4-butylbenzaldehyde, 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, 2-, 3- and 4-nitrobenzaldehyde, 2- and 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and its 3-, 4-, 5-, 6-, 7-, and 8-position isomers, and also anthracene-9-carbaldehyde.

Suitable aldehydes of the formula (VII) are, furthermore, glyoxal, glyoxalic esters, such as methyl glyoxalate, for example, and cinnamaldehyde and substituted cinnamaldehydes.

The polyaldimines ALD both of the formula (I) and of the formula (II) have the property that they are unable to form tautomeric enamines, since they contain no hydrogen as a substituent positioned α to the C atom of the imino group. Together with polyurethane polymers P containing isocyanate groups, such aldimines form storable mixtures, even in the presence of highly reactive aromatic isocyanate groups such as those of TDI and MDI.

A polyaldimine ALD is present in the polyurethane composition in a stoichiometric or substoichiometric amount, based on all of the free isocyanate groups, more particularly in an amount of 0.3 to 1.0, preferably 0.4 to 0.9, more preferably 0.5 to 0.8, equivalent of aldimine groups per equivalent of isocyanate groups.

As polyaldimine ALD it is also possible to use mixtures of different polyaldimines, including more particularly mixtures of different polyaldimines prepared using different polyamines of the formula (V), reacted with different or identical aldehydes of the formula (VI) or (VII). It may also be entirely advantageous to use mixtures of polyaldimines ALD, by using mixtures of diamines and triamines of the formula (V).

It is also possible for further polyaldimines, in addition to at least one polyaldimine ALD, to be present in the composition. Thus it is possible, for example, to react a polyamine of the formula (V) with a mixture comprising an aldehyde of the formula (VI) or (VII) and a dialdehyde. Another possibility is to use an aldehyde mixture which as well as an aldehyde of the formula (VI) and/or (VII) comprises further aldehydes. However, it must be ensured that such further polyamines or aldehydes are selected, in terms of their identity and amount, such that neither the storage stability nor the low-temperature properties of the composition are adversely affected.

The polyurethane composition advantageously comprises at least one filler F. The filler F influences not only the rheological properties of the uncured composition, more particularly the processing properties, but also the mechanical properties and the surface nature of the cured composition. Suitable fillers F are organic and inorganic fillers, examples being natural, ground or precipitated calcium carbonates, where appropriate coated with stearates, and also carbon blacks, calcinated kaolins, aluminas, silicas, PVC powders or hollow beads. Preferred fillers are calcium carbonates.

A suitable amount of filler F is dependent on the particle size and on the specific weight of the filler. A typical amount of calcium carbonate having an average particle diameter in the range from 0.07 to 7 μm, for example, is in the range from 10% to 70% by weight, preferably 20% to 60% by weight, based on the polyurethane composition.

It is entirely possible and may even be of advantage to use a mixture of different fillers F. It may also be advantageous to use a mixture of different types of calcium carbonate.

It is advantageous, furthermore, if the polyurethane composition comprises at least one thickener V. A thickener V, in interaction with the other components present in the composition, more particularly with the polyurethane polymer P and, where appropriate, a filler F, may alter the consistency of the composition. Preferably a thickener V influences the consistency of the composition so as to give a pasty material having structural viscosity properties, which exhibits good processing properties on application. Good processing properties for a joint sealant involves the uncured material being readily extrudable from the pack—a cartridge, for example—then having good firmness and short stringing if application is interrupted, and subsequently being readily modelable into the desired form (also referred to as smoothing).

Examples of suitable thickeners V are urea compounds, polyamide waxes, bentonites or fumed silicas. A typical amount used of a thickener V in the form for example of a urea compound, is situated for example in the range from 0.5 to 10% by weight, based on the polyurethane composition. A thickener V may also be employed as a paste in, for example, a plasticizer.

It may be advantageous to use a combination of two or more thickeners V in order to optimize the consistency of the composition.

Further to at least one polyurethane polymer P, at least one polyaldimine ALD, at least one filler F where appropriate, and at least one thickener V where appropriate, the one-component moisture-curing polyurethane composition may comprise further components.

Thus, where appropriate, it is possible for at least one catalyst K to be present which accelerates the hydrolysis of the aldimine groups and/or the reaction of the isocyanate groups.

Examples of catalysts K which accelerate the hydrolysis of the polyaldimine ALD are organic carboxylic acids, such as benzoic acid or salicylic acid, organic carboxylic anhydrides, such as phthalic anhydride or hexahydrophthalic anhydride, silyl esters of organic carboxylic acids, organic sulfonic acids such as p-toluenesulfonic or 4-dodecylbenzenesulfonic acid, sulfonic esters, other organic or inorganic acids, or mixtures of the aforementioned acids and acid esters.

Catalysts K which accelerate the reaction of the isocyanate groups with water are, for example, organotin compounds such as dibutyltin dilaurate, dibutyltin dichloride, dibutyltin diacetylacetonate, organobismuth compounds or bismuth complexes, or compounds containing amine groups, such as 2,2′-dimorpholinodiethyl ether or 1,4-diazabicyclo[2.2.2]-octane, for example, or other catalysts, typical within polyurethane chemistry, for the reaction of the isocyanate groups.

It can be advantageous for the polyurethane composition to include a mixture of two or more catalysts K, more particularly a mixture of an acid and an organometallic compound or a metal complex, of an acid and a compound containing amino groups, or a mixture of an acid, an organometallic compound or a metal complex, and a compound containing amine groups.

A typical amount of catalyst K is commonly 0.005% to 2% by weight, based on the total polyurethane composition, it being clear to the skilled worker what quantities are sensible to use for which catalysts.

As further components, furthermore, the following auxiliaries and adjuvants may be present among others:
plasticizers, examples being esters of organic carboxylic acids or their anhydrides, such as phthalates, such as dioctyl phthalate or diisodecyl phthalate, for example, adipates, such as dioctyl adipate, for example, and sebacates, organic phosphoric and sulfonic esters or polybutenes;
solvents, examples being ketones such as acetone, methyl ethyl ketone, diisobutyl ketone, acetonylacetone, mesityl oxide, and also cyclic ketones such as methylcyclohexanone and cyclohexanone; esters such as ethyl acetate, propyl acetate or butyl acetate, formates, propionates or malonates; ethers such as ketone ethers, ester ethers and dialkyl ethers such as diisopropyl ether, diethyl ether, dibutyl ether, diethylene glycol diethyl ether and also ethylene glycol diethyl ether; aliphatic and aromatic hydrocarbons such as toluene, xylene, heptane, octane, and also various petroleum fractions such as naphtha, white spirit, petroleum ether or benzine; halogenated hydrocarbons such as methylene chloride; and also N-alkylated lactams such as N-methylpyrrolidone, N-cyclohexylpyrrolidone or N-dodecylpyrrolidone, for example;
fibers, of polyethylene, for example;
pigments, titanium dioxide for example;
further catalysts customary within polyurethane chemistry;
reactive diluents and crosslinkers, examples being polyisocyanates such as MDI, PMDI, TDI, HDI, 1,12-dodecamethylene diisocyanate, cyclohexane 1,3- or 1,4-diisocyanate, IPDI, perhydro-2,4′- and -4,4′-diphenylmethane diisocyanate, 1,3- and 1,4-tetramethylxylylene diisocyanate, oligomers and polymers of these polyisocyanates, more particularly isocyanurates, carbodiimides, uretonimines, biurets, allophanates, and iminooxadiazinediones of the stated polyisocyanates, adducts of polyisocyanates with short-chain polyols, and also adipic dihydrazide and other dihydrazides;
dryers, such as p-tosyl isocyanate and other reactive isocyanates, orthoformic esters, calcium oxide; vinyltrimethoxysilane or other fast-hydrolyzing silanes such as organoalkoxysilanes, for example, which have a functional group positioned a to the silane group, or molecular sieves;
adhesion promoters, more particularly silanes such as, for example, epoxysilanes, vinylsilanes (meth)acrylosilanes, isocyanatosilanes, carbamatosilanes, S-(alkylcarbonyl)mercaptosilanes, and aldiminosilanes, and also oligomeric forms of these silanes;
stabilizers against heat, light radiation and UV radiation;
flame retardants;
surface-active substances such as wetting agents, flow control agents, deaerating agents or defoamers, for example;
biocides such as, for example, algicides, fungicides or fungal growth inhibitors;
   and also further substances typically used in one-component polyurethane compositions.

It is advantageous to take care that not only the polyaldimine ALD but also any filler F present, any thickener V present, any catalyst K present, and also all further components present in the composition, do not detract from the storage stability. This means that, during storage, they must not significantly initiate the reactions that lead to crosslinking, such as hydrolysis of the aldimine groups or crosslinking of the isocyanate groups. More particularly this means that all of these components ought not to contain any water, or ought to contain traces, at most, of water. It can be sensible to subject certain components to chemical or physical drying before their incorporation by mixing into the composition. Particularly suitable for drying the fillers are polyisocyanates, such as TDI, MDI, IPDI, HDI, and their oligomeric forms. The fillers can be dried with them before being mixed in, or in situ in the moisture-curing composition.

The one-component moisture-curing composition contains isocyanate groups. It has an isocyanate group content (NCO content) of not more than 3.5% by weight, more particularly of 0.2 to 3.5% by weight, based on the sum of the isocyanate-group-containing constituents present in the composition. If, therefore, in addition to the polyurethane polymer P, there are further compounds containing isocyanate groups present in the composition, such as monomeric or oligomeric diisocyanates or polyisocyanates, for example, then the overall NCO content ought to amount at most to 3.5% by weight, based on the total weight of the polyurethane polymer P and of these further compounds containing isocyanate groups. Owing to the low NCO content of not more than 3.5% by weight, more particularly in the range of 0.2% to 3.5% by weight, of the constituents containing isocyanate groups, the composition in the cured state has flexibility properties. Where the composition, in addition to the polyurethane polymer P, contains sufficient monomeric or oligomeric diisocyanate or polyisocyanate that the NCO content together with the polyurethane polymer P is situated higher than 3.5% by weight, then the composition in the cured state has too high a fraction of urea groups. Too high a fraction of urea groups in the cured composition, however, raises the elongation stress in the region up to 100% elongation above the extent that is appropriate for use as a flexible sealant.

The composition preferably contains 0.5 to 3.0% by weight of NCO groups, based on the sum of the isocyanate-group-containing constituents present in the composition.

The one-component moisture-curing composition described is prepared and stored in the absence of moisture. It is storage-stable—that is, in the absence of moisture, lit can be stored in a suitable pack or facility, such as a drum, a pouch or a cartridge, for example, for a period of several months up to one year or more, without change in its application properties or in its properties after curing, to any extent that is relevant for its use. Typically the storage stability is determined via measurement of the viscosity or of the extrusion force.

The property of the aldimine groups of the polyaldimine ALD is of hydrolyzing on contact with moisture. The isocyanate groups present in the composition react formally with the liberated polyamine of the formula (V), with liberation of the corresponding aldehydes of the formula (VI) or (VII). In proportion to the aldimine groups, excess isocyanate groups react with the water that is present. Finally, as a result of these reactions, the composition cures; this process is also referred to as crosslinking. The reaction of the isocyanate groups with the hydrolyzing polyaldimine ALD need not necessarily take place via the polyamine. It will be appreciated that reactions with intermediates of the hydrolysis of the polyaldimine ALD to give the polyamine are also possible. It is conceivable, for example, for the hydrolyzing polyaldimine ALD to react in the form of a hemiaminal directly with the isocyanate groups.

The water that is needed for the curing reaction may in one case come from the air (atmospheric humidity), or else the composition may be contacted with a water-containing component, as for example by spreading, with a smoothing agent for example, or by spraying, or a water-containing component can be added to the composition during application, in the form for example of a hydrous paste which is mixed in, for example, via a static mixer.

The polyurethane composition described cures on contact with moisture. The skinning time and the cure rate can be controlled where appropriate through the admixing of a catalyst K.

In the cured state, the composition possesses flexibility properties. In other words, on the one hand it has a low stress at 100% elongation, typically <1 MPa, and on the other hand it possesses very high extensibility, with a elongation at break of typically >500%, and good resilience, typically >70%. Outstanding, however, is the fact that the elongation stress both at room temperature and at low temperature, as for example at −20° C. is almost consistently low. The stress at 100% elongation between room temperature and −20° C. changes preferably only by a factor in the region of <1.5, i.e., σ_{100%(-20° C.)}/σ_{100%(RT)}<1.5. For a polyurethane composition this is a surprisingly low figure. Prior-art polyurethane compositions containing isocyanate groups, and containing polyaldimines with an amine equivalent weight of the corresponding polyamine of <180 g/eq, typically have a corresponding factor of toward 2 or even 3.

This consistently low elongation stress at low temperature on the part of the polyurethane compositions described signifies a step forward in the field of flexible sealants for motion joints in the exterior segment of built structures. So-called movement joints are joints which are present at suitable locations and in suitable width in built structures in order to allow movement of rigid construction materials such as concrete, stone, plastic, and metal relative to one another. Particularly at low temperatures, the materials contract, and the joints open as a result. At low temperatures, therefore, a sealant that seals the joint will be extended. In order to seal the joint durably, the sealant ought not to have too high an elongation stress in the region up to 100% elongation. The specific requirements on joint sealants for construction are laid down in standards, as for example in the ISO standard 11600, where for flexible sealants the stress in the low elongation range up to 100% at room temperature and at −20° C. must not be too high. As a result of the virtually consistently low elongation stress at low temperature and at room temperature, the compositions described make it significantly easier to formulate a sealant in accordance with ISO 11600.

In the cured state, the one-component moisture-curing compositions described are aging-resistant. In other words, the mechanical properties, following aging, even after aging which has been brought on in an accelerated way, do not alter to any extent relevant for their use. More particularly, the 100% elongation stress of the composition changes only slightly when the material is subjected to pretreatment as in ISO 8339 method B, in other words to an alternating cycle between dry heat at 70° C. and immersion in distilled water at room temperature, or a corresponding alternating cycle between dry heat at 70° C. and immersion into aqueous saturated calcium hydroxide solution at room temperature.

In application, more particularly as a sealant, the composition is applied between two substrates S1 and S2, and then curing takes place. Typically the sealant is injected into a joint.

The substrate S1 may be the same as or different from substrate S2.

Suitable substrates S1 or S2 are, for example, inorganic substrates such as glass, glass ceramic, concrete, mortar, brick, tile, plaster, and natural stone such as granite or marble; metals or alloys such as aluminum, steel, nonferrous metals, galvanized metals; organic substrates such as wood, plastics such as PVC, polycarbonates, PMMA, polyesters, epoxy resins; coated substrates such as powder-coated metals or alloys; and also inks and paints.

The substrates may if necessary be pretreated prior to the application of the sealant. Such pretreatments include, more particularly, physical and/or chemical cleaning processes, examples being abraiding, sandblasting, brushing or the like, or treatment with cleaners or solvents, or the application of an adhesion promoter, an adhesion promoter solution or a primer.

Sealing of the substrates S1 and S2 by means of a composition of the invention produces a sealed article. An article of this kind may be a built structure, more particularly a built structure in construction or civil engineering, or a part thereof, such as a window or a floor, for example, or an article of this kind may be a means of transport, more particularly a land or water vehicle, or a part thereof.

The composition described preferably has a pasty consistency with properties of structural viscosity. A pasty sealant of this kind is applied between the substrates S1 and S2 by means of a suitable apparatus. Suitable methods of application of a pasty sealant are, for example, application from commercially customary cartridges, which are operated preferably manually. Application by means of compressed air from a commercially customary cartridge or from a drum or hobbock by means of a conveying pump or an extruder, where appropriate by means of an application robot, is likewise possible.

### EXAMPLES

### Description of Test Methods

The viscosity was measured on a thermostated cone/plate viscometer, Physica UM (cone diameter 20 mm, cone angle 1°, cone tip/plate distance 0.05 mm, shear rate 10 to 1000 s⁻¹).

The amine equivalent weight of the polyamines and the aldimino group content of the polyaldimines prepared (“amine content”) were determined by titrimetry (with 0.1 N HClO₄ in glacial acetic acid, against crystal violet). The aldimino group content is reported as the amine content in mmol NH₂/g.

The skinning time (time until freedom from tack is obtained, tack-free time) was determined at 23° C. and 50% relative humidity.

The Shore A hardness was determined in accordance with DIN 53505.

The tensile strength and the elongation at break were determined in accordance with DIN 53504 (pulling speed: 200 mm/min) on films with a thickness of 2 mm cured under standard conditions (23±1° C., 50±5% relative humidity) for 14 days.

The stress at 100% elongation was determined in accordance with DIN EN 28339 and identified as “σ_{100% (-20° C.)}” (measured at −20° C.) and “σ_{100%(RT)}” (measured at room temperature, 23° C.). In the production of the test specimens, the adhesion surfaces were pretreated with Sika® Primer-3. Prior to the tensile test, the test specimens were stored under standard conditions for 14 days.

### Raw Materials Used

| | |
|---|---|
| Acclaim ® 4200N | Bayer; low monol polyoxypropylenediol, |
| | average molecular weight about 4000 |
| | g/mol, OH number 28 mg KOH/g, water |
| | content 0.02% |
| Voranol ® CP 4755 | Dow Chemical; ethylene oxide-terminated |
| | polyoxypropylenetriol, average |
| | molecular weight about 4700 g/mol, OH |
| | number 35 mg KOH/g, water content 0.02% |
| Desmodur ® T-80 P | Bayer; 2,4- and 2,6-tolylene |
| | diisocyanate in 80:20 ratio, NCO |
| | equivalent weight 87 g/eq |
| Jeffcat ® TD-33A | Huntsman; 33% 1,4-diazabicyclo[2.2.2]- |
| | octane in dipropylene glycol |
| Jeffamine ® D-230 | Huntsman; alpha, omega-polyoxypropylene- |
| | diamine, amine equivalent weight |
| | 119 g/eq |
| Jeffamine ® D-400 | Huntsman; alpha, omega-polyoxypropylene- |
| | diamine, amine equivalent weight |
| | 221 g/eq |
| Jeffamine ® D-2000 | Huntsman; alpha,omega-polyoxypropylene- |
| | diamine, amine equivalent weight |
| | 980 g/eq |
| Jeffamine ® T-5000 | Huntsman; polyoxypropylenetriamine, |
| | amine equivalent weight 1870 g/eq |
| Geniosil ® GF 80 | Wacker; (3-glycidyloxypropyl)trimeth- |
| | oxysilane |

### a) Preparation of Polyurethane Polymers

### Polymer P1

In the absence of moisture, 1000 g of Acclaim® 4200N polyol, 500 g of Voranol® CP 4755, 124.3 g of Desmodur® T-80 P, and 1.5 g of Jeffcat® TD-33A were stirred at 80° C. until the isocyanate content of the mixture gave a constant figure of 1.5%. The polymer obtained was cooled to room temperature and stored in the absence of moisture. It had a viscosity of 20 Pa s at 20° C.

### Polymer P2

In the absence of moisture, 1000 g of Acclaim® 4200N polyol, 2000 g of Voranol® CP 4755, 385 g of diisodecyl phthalate, 461.4 g of 4,4′-diphenylmethane diisocyanate (having an NCO equivalent weight of 125.6 g/eq), and 0.35 g of Jeffcat® TD-33A were stirred at 80° C. until the isocyanate content of the mixture gave a constant figure of 2.0%. The polymer obtained was cooled to room temperature and stored in the absence of moisture. It had a viscosity of 57 Pas at 20° C.

### b) Preparation of Polyaldimines

### Polyaldimine ALD1 (Comparative)

A round-bottomed flask was charged under a nitrogen atmosphere with 230.34 g (2.17 mol) of benzaldehyde. With vigorous stirring, 250.00 g (2.10 mol of NH₂) of Jeffamine® D-230 were added slowly from a dropping funnel. Thereafter, at 80° C., the volatile constituents were distilled off completely under reduced pressure. This gave 439.6 g of yellowish reaction product, liquid at room temperature, with an aldimine content, determined as amine content, of 4.77 mmol NH₂/g.

### Polyaldimine ALD2

A round-bottomed flask was charged under a nitrogen atmosphere with 123.34 g (1.16 mol) of benzaldehyde. With vigorous stirring, 250.00 g (1.13 mol of NH₂) of Jeffamine® D-400 were added slowly from a dropping funnel. Thereafter, at 80° C., the volatile constituents were distilled off completely under reduced pressure. This gave 350.9 g of yellowish reaction product, liquid at room temperature, with an aldimine content, determined as amine content, of 3.20 mmol NH₂/g.

### Polyaldimine ALD3

A round-bottomed flask was charged under a nitrogen atmosphere with 27.87 g (0.263 mol) of benzaldehyde. With vigorous stirring, 250.00 g (0.255 mol of NH₂) of Jeffamine® D-2000 were added slowly from a dropping funnel. Thereafter, at 80° C., the volatile constituents were distilled off completely under reduced pressure. This gave 272.3 g of yellowish reaction product, liquid at room temperature, with an aldimine content, determined as amine content, of 0.93 mmol NH₂/g.

### Polyaldimine ALD4

A round-bottomed flask was charged under a nitrogen atmosphere with 76.23 g (0.268 mol) of 2,2-dimethyl-3-lauroyloxypropanal. With vigorous stirring, 250.00 g (0.255 mol of NH₂) of Jeffamine® D-2000 were added slowly from a dropping funnel. Thereafter, at 80° C., the volatile constituents were distilled off completely under reduced pressure. This gave 321.2 g of yellowish reaction product, liquid at room temperature, with an aldimine content, determined as amine content, of 0.79 mmol NH₂/g.

### Polyaldimine ALD5

A round-bottomed flask was charged under a nitrogen atmosphere with 63.91 g (0.225 mol) of 2,2-dimethyl-3-lauroyloxypropanal. With vigorous stirring, 400.00 g (0.214 mol of NH₂) of Jeffamine® T-5000 were added slowly from a dropping funnel. Thereafter, at 80° C., the volatile constituents were distilled off completely under reduced pressure. This gave 459.43 g of yellowish reaction product, liquid at room temperature, with an aldimine content, determined as amine content, of 0.46 mmol NH₂/g.

### c) Preparation of Urea-Thickener Paste

A vacuum mixer was charged with 1000 g of diisodecyl phthalate and 160 g of 4,4′-diphenylmethane diisocyanate, and this initial charge was gently heated. Then, with vigorous stirring, 90 g of monobutylamine were added slowly dropwise. The white paste which formed was stirred further for an hour, under reduced pressure and with cooling. The urea-thickener paste contains 20% by weight of urea thickener in 80% by weight of diisodecyl phthalate.

### d) Preparation of the Sealant Compositions

In a vacuum mixer, the raw materials of Examples 1 to 6, as specified in Table 1, were each processed to a homogeneous paste, which was stored in the absence of moisture.

The results of Examples 1 to 6 are likewise set out in Table 1.

### e) Discussion of Results of Examples 1 to 6

Example 1 is a comparative example. It contains polyaldimine ALD1, which is a non-inventive polyaldimine, derived from Jeffamin® D-230, which has an amine equivalent weight of 119 g/eq. Although the values measured at room temperature are in accordance with a material having flexibility properties, the increase in the stress at 100% elongation between room temperature and −20° C., with a factor of 1.88, is too high.

Examples 2 to 6 are inventive examples which exhibit the desired low-temperature performance. The figures for the stress at 100% elongation at room temperature and at −20° C. are much closer to one another. The ratio of the elongation stress values between −20° C. and room temperature is significantly lower than in the case of Example 1.

TABLE 1
Composition and test results of the adhesives of Examples
1 to 6. The quantities are in parts by weight.

| | Example | | | | | |
|---|---|---|---|---|---|---|
| | 1 | | | | | |
| | (comp.) | 2 | 3 | 4 | 5 | 6 |
| Chalk | 310.0 | 300.0 | 210.0 | 388.0 | 230.0 | 210.0 |
| PVC powder | 100.0 | 100.0 | 100.0 | _{—} | 100.0 | 100.0 |
| Titanium dioxide | 20.0 | 20.0 | 20.0 | 20.0 | 20.0 | 20.0 |
| Desmodur ® T-80 P | 2.75 | 2.75 | 2.75 | 2.44 | 2.75 | 2.44 |
| Urea-thickener paste | 202.0 | 202.0 | 202.0 | 299.0 | 200.0 | 220.0 |
| Salicylic acid¹ | 12.0 | 12.0 | 12.0 | 15.0 | 12.0 | 15.0 |
| Polymer P1 | 325.0 | 325.0 | 325.0 | 180.0 | 220.0 | 240.0 |
| Polymer P2 | — | — | — | — | 70.0 | — |
| Geniosil ® GF 80 | 2.0 | 2.0 | 2.0 | 2.0 | 2.0 | 2.0 |
| Polyaldimine ALD1 | 24.0 | — | — | — | — | — |
| Polyaldimine ALD2 | — | 36.0 | — | — | — | — |
| Polyaldimine ALD3 | — | — | 124.7 | — | — | — |
| Polyaldimine ALD4 | — | — | — | 90.0 | 147.0 | — |
| Polyaldimine ALD5 | — | — | — | — | — | 209.3 |
| NCO content [% by wt.]² | 1.9 | 1.9 | 1.9 | 2.1 | 2.1 | 2.0 |
| Skinning time [min] | 50 | 30 | 35 | 20 | 9 | 30 |
| Shore A | 39 | 38 | 28 | 25 | 24 | 42 |
| Tensile strength [MPa] | 1.3 | 2.5 | 1.9 | 0.9 | 2.2 | 1.5 |
| Elongation at break [%] | 700 | 1100 | 1400 | 1050 | 1300 | 720 |
| σ_{100% (RT)} [MPa] | 0.65 | 0.68 | 0.41 | 0.42 | 0.34 | 0.8 |
| σ_{100% (-20° C.)} [MPa] | 1.22 | 0.97 | 0.52 | 0.54 | 0.45 | 1.0 |
| σ_{100% (-20° C.)}/σ_{100% (RT)} | 1.88 | 1.43 | 1.27 | 1.29 | 1.32 | 1.25 |

¹5.0% by weight in dioctyl adipate;
²NCO content of the composition in % by weight, based on the sum of the NCO- containing constituents present in the composition;

1. A one-component moisture-curing composition comprising
a) at least one polyurethane polymer P which contains isocyanate groups and has an average molecular weight of at least 4000 g/mol, and
b) at least one polyaldimine ALD of the formula (I) or (II), 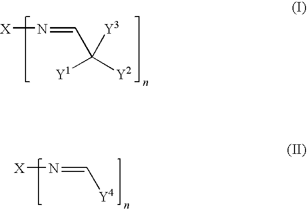
where X is the radical of an n-functional polyamine having aliphatic primary amino groups and an average amine equivalent weight of at least 180 g/eq, preferably at least 220 g/eq, following removal of n amino groups;
n is 2 or 3,
Y¹ and Y² either
independently of one another are each a monovalent hydrocarbon radical having 1 to 12 C atoms,
or together form a divalent hydrocarbon radical having 4 to 20 C atoms which is part of an unsubstituted or substituted carbocyclic ring having 5 to 8, preferably 6, C atoms, and
Y³ is a monovalent hydrocarbon radical which where appropriate has at least one heteroatom, more particularly oxygen in the form of ether, carbonyl or ester groups;
Y⁴ either
is a substituted or unsubstituted aryl or heteroaryl group which has a ring size of between 5 and 8, preferably 6, atoms,
or is 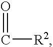
where R² is a hydrogen atom or is an alkoxy group;
or is a substituted or unsubstituted alkenyl or arylalkenyl group having at least 6 C atoms;
the isocyanate group content being not more than 3.5% by weight, based on the sum of the isocyanate-group-containing constituents present in the composition.

2. The one-component moisture-curing composition as claimed in claim 1, wherein Y³ is a radical of the formula (III) 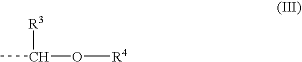
where R³ is a hydrogen atom or is an alkyl or arylalkyl group and R⁴ is an alkyl or arylalkyl group.

3. The one-component moisture-curing composition as claimed in claim 1, wherein Y³ is a radical of the formula (IV) 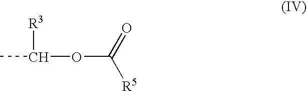
where R³ is a hydrogen atom or is an alkyl or arylalkyl group and
R⁵ is a hydrogen or an alkyl or arylalkyl or aryl group, optionally with at least one heteroatom, more particularly with at least one ether oxygen, and optionally with at least one carboxyl group, and optionally with at least one ester group, or a singly or multiply unsaturated linear or branched hydrocarbon chain.

4. The one-component moisture-curing composition as claimed in claim 1 wherein X in formula (I) or (II) is a polyoxyalkylene radical, more particularly a polyoxypropylene or a polyoxybutylene radical, it being possible for each of these radicals also to contain fractions of other oxyalkylene groups.

5. The one-component moisture-curing composition as claimed in claim 1, wherein the polyurethane polymer P is obtained from a reaction of at least one polyisocyanate with at least one polyol, the NCO/OH ratio having a value of not more than 2.5, more particularly not more than 2.2.

6. The one-component moisture-curing composition as claimed in claim 5, wherein the polyol is a polyoxyalkylene polyol, more particularly a polyoxypropylene diol or triol or an ethylene oxide-terminated polyoxypropylene diol or triol.

7. The one-component composition as claimed in claim 5, wherein the polyol has a molecular weight of 1000 to 30 000 g/mol and a degree of unsaturation of less than 0.02 meq/g.

8. The one-component moisture-curing composition as claimed in claim 1, wherein the polyurethane polymer P is present in an amount of 10%-80% by weight, preferably in an amount of 15%-50% by weight, based on the overall polyurethane composition.

9. The one-component moisture-curing composition as claimed in claim 1, wherein the polyaldimine ALD is present in an amount of 0.3 to 1.0, preferably of 0.4 to 0.9, more preferably 0.5 to 0.8, equivalent of aldimine groups per equivalent of isocyanate groups in the composition.

10. The one-component moisture-curing composition as claimed in claim 1, wherein it further comprises at least one filler F, more particularly calcium carbonate.

11. The one-component moisture-curing composition as claimed in claim 1, wherein it further comprises at least one thickener V.

12. The one-component moisture-curing composition as claimed in claim 1, wherein it further comprises at least one catalyst K which accelerates the hydrolysis of the aldimine groups and/or the reaction of the isocyanate groups.

13. The use of a composition as claimed in claim 1 as a sealant.

14. A method of sealing comprising the steps of
(i) applying a composition as claimed in claim 1 between a substrate S1 and a substrate S2,
(ii) curing the composition by contact with moisture,
the substrates S1 and S2 being alike or different from one another.

15. The method as claimed in claim 14, wherein at least one of the substrates, S1 or S2, is glass, glass ceramic, concrete, mortar, brick, tile, plaster, a natural stone such as granite or marble, a metal or an alloy such as aluminum, steel, nonferrous metal, galvanized metal; a wood, a plastic such as PVC, polycarbonate, PMMA, polyester, epoxy resin; a powder coating, an ink or a paint, more particularly an automobile finish.

16. A sealed article produced by means of a method of sealing as claimed in claim 14.

17. The sealed article as claimed in claim 16, wherein the article is a built structure, more particularly a built structure in construction or civil engineering, or a part thereof or a means of transport, more particularly a land or water vehicle, or a part thereof.

18. The use of the polyaldimine ALD of the formula (I) or (II) as present in a one-component moisture-curing composition as claimed in claim 1 in sealants.

19. The use of the polyaldimine ALD of the formula (I) or (II) as present in a one-component moisture-curing composition as claimed in claim 1 to improve the low-temperature performance of cured polyurethane compositions by virtue of the ratio σ_{100%(-20° C.)}/σ_{100%(RT)} of the 100% elongation stress at −20° C. to the 100% elongation stress at 23° C. being a value of <1.5.
